(19) United States
(12) Patent Application Publication
(10) Pub. No.: US 2025/0150987 A1
(43) Pub. Date: May 8, 2025

(54) MEDIUM ACCESS CONTROL (MAC) CONTROL ELEMENT (CE) DESIGN FOR MULTIPLE POWER MANAGEMENT MAXIMUM POWER REDUCTION (P-MPR) REPORTING

(71) Applicant: Telefonaktiebolaget LM Ericsson (publ), Stockholm (SE)

(72) Inventors: Siva MURUGANATHAN, Stittsville (CA); Shiwei GAO, Nepean (CA); Andreas NILSSON, Göteborg (SE)

(21) Appl. No.: 18/730,203

(22) PCT Filed: Jan. 19, 2023
(86) PCT No.: PCT/IB2023/050471

§ 371 Date: Jul. 18, 2024

Related U.S. Application Data
(60) Provisional application No. 63/301,273, filed on Jan. 20, 2022.

(51) Int. Cl. H04W 52/36

(52) U.S. Cl. CPC H04W 52/365; H04W 52/367

(57) ABSTRACT

A method, network node and wireless device (WD) for medium access control (MAC) control element (CE) design for multiple power management maximum power reduction (P-MPR) reporting are disclosed. According to one aspect, a method in a network node includes receiving from the WD a power headroom report (PHR) medium access control (MAC) control element (CE) that includes power headroom information for at least one serving cell and for each of the at least one serving cell, information for a plurality of P-MPR, values and candidate beam information associated to at least one of the plurality of P-MPR values. The method also includes determining, for each of the plurality of P-MPR values, a presence of candidate beam information in the MAC CE based at least in part on a bit content in at least one associated field of the MAC CE.

### FIELD

The present disclosure relates to wireless communications, and in particular, to medium access control (MAC) control element (CE) design for multiple power management maximum power reduction (P-MPR) reporting.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

The next generation mobile wireless communication system (5G) or new radio (NR), will support a diverse set of use cases and a diverse set of deployment scenarios. The latter includes deployment at both low frequencies (below 6 GHz) and very high frequencies (up to 10 s of GHz).

### NR Frame Structure and Resource Grid

NR uses CP-OFDM (Cyclic Prefix Orthogonal Frequency Division Multiplexing) in both downlink (DL) transmissions, (i.e. from a network node, gNB, or base station, to a user equipment or wireless device WD) and uplink (UL) transmissions, (i.e., from WD to gNB). Discrete Fourier transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot has 14 OFDM symbols.

Data scheduling in NR is typically on a per slot basis. An example is shown in FIG. 1 with a 14-symbol slot, where the first two symbols contain physical downlink control channel (PDCCH) and the rest contains physical shared data channel, either PDSCH (physical downlink shared channel) or PUSCH (physical uplink shared channel).

Different subcarrier spacing values are supported in NR. The supported subcarrier spacing values (also referred to as different numerologies) are given by Δf=(15×24) kHz where μ={0,1,2,3,4}. Δf=15 kHz is the basic subcarrier spacing. The slot durations at different subcarrier spacings is given by 1/2^{μ} ms.

In the frequency domain, a system bandwidth is divided into resource blocks (RBs), each corresponds to 12 contiguous subcarriers. The RBs are numbered starting with 0 from one end of the system bandwidth. The basic NR physical time-frequency resource grid is illustrated in the example of FIG. 2, where only one resource block (RB) within a 14-symbol slot is shown. One OFDM subcarrier during one OFDM symbol interval forms one resource element (RE).

DL PDSCH transmissions may be either dynamically scheduled, i.e., in each slot the network node (gNB) transmits downlink control information (DCI) over PDCCH (Physical Downlink Control Channel) about which WD data is to be transmitted to and which RBs in the current downlink slot the data is transmitted on, or semi-persistently scheduled (SPS) in which periodic PDSCH transmissions are activated or deactivated by a DCI. Different DCI formats are defined in NR for DL PDSCH scheduling including DCI format 1_0, DCI format 1_1, and DCI format 1_2.

Similarly, UL PUSCH transmission may also be scheduled either dynamically or semi-persistently with uplink grants carried in PDCCH. NR supports two types of semi-persistent uplink transmission, i.e., type 1 configured grant (CG) and type 2 configured grant, where a Type 1 configured grant is configured and activated by Radio Resource Control (RRC) while a type 2 configured grant is configured by RRC but activated/deactivated by DCI. The DCI formats for scheduling PUSCH include DCI format 0_0, DCI format 0_1, and DCI format 0_2.

### NR PUSCH Transmission Schemes

In NR, two transmission schemes for PUSCH (Physical Uplink Shared Channel) are supported. One is codebook-based and the other is non-codebook based. The codebook-based PUSCH transmission scheme may be summarized as follows:
the WD transmits a Sounding Reference Signal (SRS) in an SRS resource set with a higher layer parameter usage set to ‘codebook’. Up to two SRS resources, each with up to four antenna ports may be configured in the SRS resource set;
the network node, e.g., gNB, determines an SRS resource and a number of MIMO (Multiple Input and Multiple Output) layers (or rank) and a preferred precoder, (i.e., transmit precoding matrix indicator or TPMI) associated with the SRS resource;
the network node, e.g., gNB, indicates the selected SRS resource via a 1-bit ‘SRS resource indicator’ (SRI) field in a DCI (Downlink Control Information) scheduling the PUSCH if two SRS resources are configured in the SRS resource set. The ‘SRS resource indicator’ field is not indicated in DCI if only one SRS resource is configured in the SRS resource set;
The network node, e.g., gNB, indicates the preferred TPMI and the associated number of layers corresponding to the indicated SRS resource; and
the WD performs PUSCH transmission using the TPMI and the number of layers indicated over the SRS antenna ports.

Non-Codebook based UL transmission is for reciprocity-based UL transmission in which SRS precoding is derived at a WD based on a configured DL Channel State Information Reference Signal (CSI-RS). The WD derives a suitable precoder for SRS transmission based on the CSI-RS and creates one or more (virtual) SRS ports, each corresponding to a spatial layer. Up to four SRS resources, each with a single (virtual) SRS port may be configured in a SRS resource set. A WD may transmit SRS in the up to four SRS resources and the network node measures on an UL channel based on the received SRS and determines the preferred SRS resource(s). Subsequently, the network node indicates the selected SRS resources via a SRS resource indicator (SRI) in a DCI scheduling a PUSCH.

Note that up to 3GPP Technical Release 16 (3GPP Rel-16) in NR, only a single SRS resource set may be configured with usage set to “nonCodebook” or “codebook”.

### NR 3GPP Rel-15 Power Control for PUSCH

Uplink power control is used to determine a PUSCH transmit power. The uplink power control in NR has two parts, i.e., open-loop and closed-loop power controls. Open-loop power control is determined by a WD and is used to set the uplink transmit power based on the pathloss estimation and some other factors such as the target receive power, scheduled bandwidth, modulation and coding scheme (MCS), fractional power control factor, etc. Closed-loop power control is based on power control commands received from the network node, e.g., gNB.

With multi-beam transmission in FR2 (NR frequency range 2), the pathloss may be different with different transmit and receive beam pairs. To support transmission with different beam pairs, each beam pair may be associated with a pathloss reference signal (RS). Pathloss associated with a beam pair may be measured based on the associated pathloss RS. A pathloss RS may be a Synchronization Signal (SS) and Physical Broadcast Channel (PBCH) block (SSB) or a CSI-RS.

FIG. 3 shows an example of PUSCH transmitted in beam #1 with CSI-RS #1 configured as the pathloss reference RS. Similarly, for PUSCH transmitted in beam #2, CSI-RS #2 may be configured as the pathloss reference RS.

For a PUSCH to be transmitted in a UL beam pair associated with a pathloss RS with index k, its transmit power in a transmission occasion i within a slot in a bandwidth part (BWP) of a carrier frequency f of a serving cell c and a closed-loop index l (l=0,1) may be determined as:

$${P}_{b , f , c} ( i , k , l ) = min \{ \begin{matrix}{P}_{CMAX , f , c} ( i ) \\ {P}_{b , f , c , open - loop} ( i , k ) + {P}_{b , f , c , closed - loop} ( i , l )\end{matrix}$$

where P_{CMAX,f,c}(i) is the configured WD maximum output power for the carrier frequency f of the serving cell c in transmission occasion i; P_{b,f,c,closed-loop}(i,l) is the closed loop power adjustment; P_{b,f,c,open-loop}(i,k) is the open loop power adjustment and is given by:

$${P}_{b , f , c , open - loop} ( i , k ) = {P}_{O , b , f , c} ( j ) + {P}_{RB , b , f , c} ( i ) + {α}_{b , f , c} ( j ) {PL}_{b , f , c} ( k ) + {Δ}_{MCS , b , f , c} ( i )$$

where P_{O,b,f,c}(j) is the nominal target receive power for a parameter set configuration with index j and comprises a cell specific part P_{O_Nomina_PUSCH,f,c}(j) and a WD specific part P_{O_UE_PUSCH,b,f,c}(j), P_{RB,b,f,c}(i) is a power adjustment related to the number of RBs scheduled in a transmission occasion i, PL_{b,f,c}(k) is the pathloss estimation based on the pathloss reference signal with index k, α_{b,f,c} is fractional pathloss compensation factor, and Δ_{MCS,b,f,c}(i) is a power adjustment related to MCS. For PUSCH associated with a random access (RACH) procedure, j=0, and P_{O_UE_PUSCH,b,f,c}(0)=0.

For configured grant based PUSCH, j=1, and P_{O_NOMINAL_PUSCH,f,c}(1) is provided by p0-NominalWithoutGrant, or P_{O_NOMINAIPUSCHf,c}(1)=P_{O_NOMINAIPUSCHf,c}(0) if p0-NominalWithoutGrant is not provided, and P_{O_UE_PUSCHb,f,c}(1) is provided by p0 obtained from p0-PUSCH-Alpha in ConfiguredGrantConfig that provides an index P0-PUSCH-AlphaSetId to a set of P0-PUSCH-AlphaSet for active UL BWP b of carrier f of serving cell c.

For dynamically scheduled PUSCH, j>1, P_{ONomina}_{_{PUSCH}}_{,f,c}(j) is provided by p0-NominalWithGrant, or P_{ONomina}_{_{PUSCH}}_{,f,c}(j)=P_{ONomina}_{_{PUSCH}}_{,f,c}(0) if p0-NominalWithGrant is not provided. P_{O-UE-PUSCH,b,f,c}(f) is provided by p0 in a P0-PUSCH-AlphaSet indicated by a respective p0-PUSCH-AlphaSetId for active UL BWP b of carrier f of serving cell c as shown in FIG. 4, where the WD first obtains a sri-PUSCH-PowerControlId from the SRI field and then the p0-PUSCH-AlphaSetId from the sri-PUSCH-PowerControl with the sri-PUSCH-PowerControlId.

If the DCI format also includes an open-loop power control (OLPC) parameter set indication field and a value of the open-loop power control parameter set indication field is ‘1’, the WD determines a value of P_{O_UE_PUSCH,b,f,c}(j) from a first value in a P0-PUSCH-Set with a p0-PUSCH-SetId value mapped to the SRI field value.

If the PUSCH transmission is scheduled by a DCI format that does not include an SRI field, or if SRI-PUSCH-PowerControl is not provided to the WD, j=2. If P0-PUSCH-Set is provided to the WD and the DCI format includes an open-loop power control parameter set indication field, the WD determines a value of P_{O_UE_PUSCH,b,f,c}(j) from:
a first P0-PUSCH-AlphaSet in p0-AlphaSets if a value of the open-loop power control parameter set indication field is ‘0’ or ‘00’;
a first value in P0-PUSCH-Set with the lowest p0-PUSCH-SetID value if a value of the open-loop power control parameter set indication field is ‘1’ or ‘01’;
a second value in P0-PUSCH-Set with the lowest p0-PUSCH-SetID value if a value of the open-loop power control parameter set indication field is ‘10’;
else, the WD determines P_{O_UE_PUSCH,b,f,c}(j) from the value of the first P0-PUSCH-AlphaSet in p0-AlphaSets.

### NR 3GPP Rel-16 Power Head Room Reporting

The uplink power availability at a WD, or power headroom (PH), is provided to the network node, e.g., gNB. A PH report (PHR) is transmitted from the WD to the network node, e.g., gNB, when the WD is scheduled to transmit data on PUSCH. A PHR may be triggered periodically or when certain conditions are met such as when the pathloss difference between the current PHR and the last report is larger than a configurable threshold.

There are two different types of PHRs defined in NR, i.e., Type 1 and Type 3. Type 1 PHR reflects the power headroom assuming PUSCH-only transmission on a carrier and is defined as the difference between the nominal WD maximum transmit power, P_{CMAX}, and an estimated power for PUSCH transmission with UL shared channel (UL-SCH) per activated Serving Cell. A negative PHR indicates that the per-carrier transmit power is limited by P_{CMAX} at the time of the power headroom reporting for the PUSCH.

The type 1 PHR may be based on either an actual PUSCH transmission carrying the PHR report or a reference PUSCH transmission (aka, virtual PHR) if the time between a PHR report trigger and the corresponding PUSCH carrying the PHR report is too short for a WD to complete the PHR calculation based on the actual PUSCH. The power control parameters for the reference PUSCH are pre-determined, for example, as described in 3GPP Technical Standard (TS) 38.213 v16.4.0 section 7.7.1.

Type 3 PHR is defined as the difference between the nominal WD maximum transmit power, P_{CMAX}, and an estimated power for SRS transmission per activated Serving Cell. It is used for UL carrier switching in which a PHR is reported for a carrier that is not yet configured for PUSCH transmission but is configured only for SRS transmission. Type 3 PHR may be based on either an actual SRS transmission or a reference SRS transmission, for example, as described in 3GPP TS 38.213 v16.4.0 section 7.7.3. PHR is per carrier and does not explicitly take beam-based operation into account.

Power Headroom reporting may be controlled by configuring the following higher layer parameters as described in 3GPP TS 38.331:
phr-PeriodicTimer;
phr-ProhibitTimer;
phr-Tx-PowerFactorChange;
phr-Type2OtherCell;
phr-ModeOtherCG;
multiplePHR;
mpe-Reporting-FR2;
mpe-ProhibitTimer; and
mpe-Threshold.

According to 3GPP TS 38.321 v16.7.0, section 5.4.6, a PHR is triggered if any of a list of events occur including:
phr-PeriodicTimer expires;
phr-ProhibitTimer expires or has expired and the path loss has changed more than phr-Tx-PowerFactorChange dB for at least one activated Serving Cell of any MAC (Medium Access Control) entity of which the active DL BWP is not dormant BWP which is used as a pathloss reference since the last transmission of a PHR in this MAC entity when the MAC entity has UL resources for new transmission;
upon configuration or reconfiguration of the power headroom reporting functionality by upper layers, which is not used to disable the function;
phr-ProhibitTimer expires or has expired, when the MAC entity has UL resources for new transmission, and the following is true for any of the activated Serving Cells of any MAC entity with configured uplink:
   there are UL resources allocated for transmission on this cell, and the required power backoff due to power management for this cell has changed more than phr-Tx-PowerFactorChange dB since the last transmission of a PHR when the MAC entity had UL resources allocated for transmission on this cell;
if mpe-Reporting-FR2 is configured, and mpe-ProhibitTimer is not running:
   the measured P-MPR (Power Management Maximum Power Reduction) applied to meet FR2 MPE (Maximum Permissible Exposure) requirements as specified in 3gpp TS 38.101-2 is equal to or larger than mpe-Threshold for at least one activated FR2 Serving Cell since the last transmission of a PHR in this MAC entity; or
   the measured P-MPR applied to meet FR2 MPE requirements as specified in TS 3gpp 38.101-2 has changed more than phr-Tx-PowerFactorChange dB for at least one activated FR2 Serving Cell since the last transmission of a PHR due to the measured P-MPR applied to meet MPE requirements being equal to or larger than mpe-Threshold in this MAC entity, in which case the PHR is referred to as ‘MPE P-MPR report’.
      Note that the path loss variation for one cell assessed above is between the pathloss measured at a present time on the current pathloss reference and the pathloss measured at the transmission time of the last transmission of PHR on the pathloss reference in use at that time, regardless of whether the pathloss reference has changed in between.

PHR is carried in a MAC CE which is then carried in a PUSCH. A WD may be configured by higher layers with either a single entry PHR MAC CE or multiple entry PHR MAC CE. In case of single entry PHR MAC CE, only type 1 PHR is reported. In case of multiple entry PHR MAC CE, PHRs for different serving cells may be reported, for example, according to 3GPP TS 38.321 v16.7.0 sections 5.4.6, 6.1.3.8 and 6.1.3.9. The single entry MAC CE is shown in the example of FIG. 5. The multiple entry MAC CEs are shown in the examples of FIGS. 6 and 7.

The field descriptions for the fields in the single entry and multiple entry PHR MAC CEs is given below:
R: Reserved bit, set to 0;
PH: This field indicates the power headroom level. The length of the field is 6 bits. The reported PH and the corresponding power headroom levels are shown in Table 6.1.3.8-1 below (the corresponding measured values in dB are specified in 3GPP TS 38.133);
P: If mpe-Reporting-FR2 is configured and the Serving Cell operates on FR2, the MAC entity shall set this field to 0 if the applied P-MPR value, to meet MPE requirements, as specified in TS 38.101-2, is less than P-MPR_00 as specified in 3GPP TS 38.133 and to 1 otherwise. If mpe-Reporting-FR2 is not configured or the Serving Cell operates on FR1, this field indicates whether power backoff is applied due to power management (as allowed by P-MPR_{c} as specified in 3GPP TS 38.101-1, TS 38.101-2, and TS 38.101-3). The MAC entity shall set the P field to 1 if the corresponding P_{CMAX,f,c} field would have had a different value if no power backoff due to power management had been applied;
P_{CMAX,f,c}: This field indicates the P_{CMAX,f,c} (as specified in 3GPP TS 38.213) used for calculation of the preceding PH field. The reported P_{CMAX,f,c} and the corresponding nominal WD transmit power levels are shown in Table 6.1.3.8-2 (the corresponding measured values in dBm are specified in 3GPP TS 38.133);
V: This field indicates if the PH value is based on a real transmission or a reference format. For Type 1 PH, the V field set to 0 indicates real transmission on PUSCH and the V field set to 1 indicates that a PUSCH reference format is used. For Type 2 PH, the V field set to 0 indicates real transmission on PUCCH and the V field set to 1 indicates that a PUCCH reference format is used. For Type 3 PH, the V field set to 0 indicates real transmission on SRS and the V field set to 1 indicates that an SRS reference format is used. Furthermore, for Type 1, Type 2, and Type 3 PH, the V field set to 0 indicates the presence of the octet containing the associated P_{CMAX,f,c} field and the MPE field, and the V field set to 1 indicates that the octet containing the associated P_{CMAX,f,c} field and the MPE field is omitted;
Cᵢ: This field indicates the presence of a PH field for the Serving Cell with ServCellIndex i as specified in TS 38.331 [5]. The Cᵢ field set to 1 indicates that a PH field for the Serving Cell with ServCellIndex i is reported. The Cᵢ field set to 0 indicates that a PH field for the Serving Cell with ServCellIndex i is not reported; and
MPE: If mpe-Reporting-FR2 is configured, and the Serving Cell operates on FR2, and if the P field is set to 1, this field indicates the applied power backoff to meet MPE requirements, as specified in 3GPP TS 38.101-2. This field indicates an index to Table 6.1.3.8-3 and the corresponding measured values of P-MPR levels in dB are specified in 3GPP TS 38.133. The length of the field is 2 bits. If mpe-Reporting-FR2 is not configured, or if the Serving Cell operates on FR1, or if the P field is set to 0, R bits are present instead.

TABLE 6.1.3.8-1
Power Headroom levels for PHR (reproduced
from 3GPP TS 38.321)

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |
| . . . | . . . |
| 60 | POWER_HEADROOM_60 |
| 61 | POWER_HEADROOM_61 |
| 62 | POWER_HEADROOM_62 |
| 63 | POWER_HEADROOM_63 |

TABLE 6.1.3.8-2
Nominal WD transmit power level for
PHR (reproduced from 3GPP TS 38.321)

| P_{CMAX, f, c} | Nominal WD transmit power level |
|---|---|
| 0 | PCMAX_C_00 |
| 1 | PCMAX_C_01 |
| 2 | PCMAX_C_02 |
| . . . | . . . |
| 61 | PCMAX_C_61 |
| 62 | PCMAX_C_62 |
| | PCMAX_C_63 |

TABLE 6.1.3.8-3
Effective power reduction for MPE P-
MPR (reproduced from 3GPP TS 38.321)

| MPE | Measured P-MPR value |
|---|---|
| 0 | P-MPR_00 |
| 1 | P-MPR_01 |
| 2 | P-MPR_02 |
| 3 | P-MPR_03 |

### NR 3GPP Rel-17 Enhancements on PUSCH Transmission Towards Two Transmission and Reception Points (TRPs)

A TRP is a set of geographically co-located transmit and receive antennas such as base station antennas, remote radio heads, a remote antenna of a base station, etc. A serving cell may have one or multiple TRP. In 3GPP NR Rel-17, it has been considered that PUSCH repetition to two TRPs in a cell will be supported. For that purpose, two SRS resource sets with usage set to either ‘codebook’ or ‘nonCodebook’ will be introduced, each SRS resource set is associated with a TRP. PUSCH repetition to two TRPs may be scheduled by a DCI with two SRS resource indicator (SRI) fields, where a first SRI is associated with a first SRS resource set and a second SRI is associated with a second SRS resource set.

An example is shown in FIG. 8, where a PUSCH repetition towards two TRPs is scheduled by a DCI indicating two SRIs. Both type A and type B PUSCH repetitions are supported.

Two types of mappings are supported between PUSCH transmission occasions to TRPs or UL beams, i.e.:
Cyclical mapping pattern: the first and second UL beams are applied to the first and second PUSCH repetitions, respectively, and the same beam mapping pattern continues to the remaining PUSCH repetitions; and
Sequential mapping pattern: the first beam is applied to the first and second PUSCH repetitions, and the second beam is applied to the third and fourth PUSCH repetitions, and the same beam mapping pattern continues to the remaining PUSCH repetitions, where the first and second UL beams are used to transmit PUSCH towards the first and second TRPs, respectively.

It has been considered that two sets of power control parameters will be supported, each set is associated with a SRI field in DCI formats 0_1 and 0_2;

For PHR reporting related to PUSCH repetition to two TRPs, WD may calculate and report two PHRs (at least corresponding to the CC that applies multi-TRP PUSCH repetitions), one per TRP, depending on WD capability.

### 3GPP Rel-17 Enhancement on Multiple P-MPR Reporting

At millimeter wave (mmW) frequencies (FR2), the majority of commercial WDs are equipped with multiple antenna panels pointing in different directions. Each such panel typically has a significant amount of directivity. This property is quite different compared to sub-6 GHz operation, where the WD typically is equipped with omni-directional antennas. In addition, while the multi-panel WD architecture is supported in 3GPP Rel-15/16, the beam management functionality does not explicitly take this into account and any such architecture is transparent to the network node.

Power Management WD Maximum Power Reduction (P-MPR) is the power reduction the WD may need to perform to comply with regulatory restrictions rules on MPE (Maximum Permissible Exposure). P-MPR has been introduced in 3GPP NR Rel-16 such that the WD may report to the network node the available maximum output transmit power. This may be used by the network node for scheduling decisions. In 3GPP NR Rel-16, an enhanced power head room (PHR) report was specified which could indicate if a P-MPR value has been applied by the WD to meet the MPE requirements.

An MPE event is WD panel specific and can, for example, depend on whether a finger is in close vicinity of a WD panel. This means that different WD panels might experience different P-MPR situations, and hence be associated with different available output powers.

Due to beam correspondence at the WDs, it is expected that both DL and UL beam selections in commercial products mainly will be based on measured DL performance metrics (reference signal received power (RSRP) or signal to interference plus noise ratio (SINR)) from DL beam management procedures using synchronization signal blocks (SSB) and/or channel state information reference signals (CSI-RS). However, since P-MPR is not included in DL performance measurements, the network node is unaware whether an UL beam is associated with a WD panel suffering from P-MPR, which if selected could cause UL coverage problems.

To facilitate MPE mitigation, event-triggered P-MPR-based reporting is enhanced in 3GPP Rel-17. In the enhanced PHR report in 3GPP Rel-17, N≥1 P-MPR values may be reported, where N may be 1, 2, 3 or 4 (depending on WD capability). In addition, for each of the reported N P-MPR values, the WD may indicate a new preferred beam by an SSB (synchronization signal/physical broadcast channel resource block) resource indicator (SSBRI) or CSI-RS resource indicator CRI). The WD may be radio resource control (RRC) configured with a set of candidate beams (i.e., candidate SSBRIs or CRIs), from which the indicated preferred beam is selected. The enhanced PHR report may be signaled from the WD to the network node via MAC CE signaling

Although 3GPP Rel-17 considers enhanced P-MPR (i.e., reporting of N≥1 P-MPR values) to be conveyed in a MAC CE, the detailed design of the MAC CE is not been determined

As up to four P-MPR values (and the corresponding candidate beam indices given by SSBRI/CRI fields) need to be signaled in the MAC CE, this may increase the size of the MAC CE. The size increase will increase the overall overhead of the MAC CE particularly for multiple entry MAC CEs which need to carry the information for higher than 8 serving cells. Hence, how to control the size of the MAC CE is a problem.

### SUMMARY

Some embodiments advantageously provide methods, systems, and apparatuses for medium access control (MAC) control element (CE) design for multiple power management maximum power reduction (P-MPR) reporting.

Some embodiments provide for indicating whether an MPE field and its associated SSBRI or CRI field are present in a MAC CE by allocating a control bit in the MAC CE for each of multiple MPE fields. In some embodiments, an MPE field and its associated SSBRI or CRI field are present if the associated control bit is set, otherwise they are absent. A control bit may be allocated for each of the multiple MPE fields. The presence or absence of a MPE field and the associated SSBRI/CRI field may be determined by the corresponding P-MPR value with respect to a threshold.

In some embodiments, controlling the presence or absence of each of multiple MPE fields and the associated SSBRI or CRI field in a MAC CE by a control bit field associated with each of multiple MPE fields (i.e., each MPE field and/or SSBRI or CRI field is controlled by one control bit in the MAC CE). The presence or absence of an MPE field and the associated SSBRI or CRI field may be based on the determined multiple P-MPR values with respect to a threshold, where the fields are present if the P-MPR value exceeds the threshold. Each control field bit determines whether a corresponding MPE field and the associated SSBRI or CRI fields are present. The MAC CE may be a single entry MAC CE or multiple entry MAC CE for power head room reports.

In some embodiments, a control bit in the MAC CE controls the presence or absence of a corresponding octet in the MAC CE. The corresponding octet may be or include at least one of the following:
the octet containing the SSBRI/CRI field associated to the control field bit; and/or
the octet containing the MPE field and the SSBRI/CRI field both of which are associated to the control field bit.

In some embodiments, depending on which among the multiple P-MPR values are to be reported, the WD may control the size of the MAC CE by appropriately setting the control bits that control whether one or more octets carrying the P-MPR values and/or the associated SSBRI/CRI values need to be included in the MAC CE. An advantage of some embodiments, is reduction of the overhead involved with multiple P-MPR value reporting.

According to one aspect, a network node configured to communicate with a wireless device, WD, is provided. The network node includes a radio interface configured to receive from the WD a power headroom report, PHR, medium access control, MAC, control element, CE, containing power headroom information for at least one serving cell and for each of the at least one serving cell, information for a plurality of power management maximum power reduction, P-MPR, values and candidate beam information associated to at least one of the plurality of P-MPR values. The network node also includes processing circuitry in communication with the radio interface and configured to determine, for each of the plurality of P-MPR values, a presence of candidate beam information in the MAC CE based at least in part on a bit content in at least one associated field of the MAC CE.

According to this aspect, in some embodiments, the bit content includes a first bit indicating whether first candidate beam information associated with a first P-MPR value is present in a first field of the MAC CE and includes a second bit indicating whether second candidate beam information associated with a second P-MPR value is present in a second field of the MAC CE. In some embodiments, the candidate beam information includes at least one of a corresponding synchronization signal block resource indicator, SSBRI, and a channel state information reference signal resource indicator, CRI, reported in the MAC-CE. In some embodiments, the bit content determines a variable size of the MAC CE. In some embodiments, the bit content is associated with an octet of the MAC CE, wherein the octet containing a SSBRI or CRI, and a bit of the bit content indicates a presence of the octet in the MAC CE. In some embodiments, a bit indicating a presence of candidate beam information in the MAC CE is determined based at least in part on the corresponding P-MPR value for meeting a maximum permissible exposure, MPE, requirement.

According to another aspect, a method in a network node configured to communicate with a wireless device, WD, is provided. The method includes receiving from the WD a power headroom report, PHR, medium access control, MAC, control element, CE, that includes power headroom information for at least one serving cell and for each of the at least one serving cell, information for a plurality of power management maximum power reduction, P-MPR, values and candidate beam information associated to at least one of the plurality of P-MPR values. The method also includes determining, for each of the plurality of P-MPR values, a presence of candidate beam information in the MAC CE based at least in part on a bit content in at least one associated field of the MAC CE.

In some embodiments, the bit content includes a first bit indicating whether first candidate beam information associated with a first P-MPR value is present in a first field of the MAC CE and includes a second bit indicating whether second candidate beam information associated with a second P-MPR value is present in a second field of the MAC CE. In some embodiments, the candidate beam information includes at least one of a corresponding synchronization signal block resource indicator, SSBRI, and a channel state information reference signal resource indicator, CRI, reported in the MAC-CE. In some embodiments, the bit content determines a variable size of the MAC CE. In some embodiments, the bit content is associated with an octet of the MAC CE, wherein the octet containing a SSBRI or CRI, and a bit of the bit content indicates a presence of the octet in the MAC CE. In some embodiments, a bit indicating a presence of candidate beam information in the MAC CE is determined based at least in part on the corresponding P-MPR value for meeting a maximum permissible exposure, MPE, requirement.

According to yet another aspect, a WD configured to communicate with a network node is provided. The WD includes: processing circuitry configured to: generate a power headroom report, PHR, Medium Access Control, MAC, Control Element, CE, containing power headroom information for one or more serving cells and for each of the one or more serving cells, the MAC CE being configured to include: a first power management maximum power reduction, P-MPR, indicator indicating the presence or absence of a first P-MPR value in a first bit field in the MAC CE; a second P-MPR indicator indicating the presence or absence of a second P-MPR value in a second bit field in the MAC CE; a first beam indicator indicating the presence or absence of information about a first candidate beam associated to the first measured P-MPR value in the MAC CE; and a second beam indicator indicating the presence or absence of information about a second candidate beam associated to the second measured P-MPR value in the MAC CE. The processing circuitry is further configured to adjust a size of the MAC CE based at least in part on the presence or absence of information about the first and second candidate beams in the MAC CE. The WD also includes a radio interface in communication with the processing circuitry and configured to transmit the MAC CE to the network node.

According to this aspect, in some embodiments, the information about the first or second candidate beam includes a corresponding synchronization signal block resource indicator, SSBRI, or a channel state information reference signal resource indicator, CRI, reported in the MAC-CE. In some embodiments, the information about at least one of the first and second candidate beam is contained in an octet and at least one of the first and second beam indicator indicates one of a presence and absence of the octet in the MAC CE. In some embodiments, each of the first and second beam indicators is carried by one bit in the MAC CE, wherein the corresponding candidate beam information is present when the bit is set to one, and is absent when the bit is set to zero. In some embodiments, when a list of candidate beams is not configured, no candidate beam information is included in the MAC CE. In some embodiments, the processing circuitry is further configured to configure the MAC CE with multiple sets of candidate beam information in multiple second bit fields, each set corresponding to a different serving cell.

According to another aspect, a method in a wireless device, WD, configured to communicate with a network node is provided. The method includes generating a power headroom report, PHR, Medium Access Control, MAC, Control Element, CE, containing power headroom information for one or more serving cells and for each of the one or more serving cells, the MAC CE being configured to include: a first power management maximum power reduction, P-MPR, indicator indicating the presence or absence of a first P-MPR value in a first bit field in the MAC CE; a second P-MPR indicator indicating one of a presence and an absence of a second P-MPR value in a second bit field in the MAC CE; a first beam indicator indicating the presence or absence of information about a first candidate beam associated to the first measured P-MPR value in the MAC CE; and a second beam indicator indicating the presence or absence of information about a second candidate beam associated to the second measured P-MPR value in the MAC CE. The method also includes adjusting a size of the MAC CE based at least in part on the presence or absence of information about the first and second candidate beams in the MAC CE. The method also includes transmitting the MAC CE to the network node.

According to this aspect, in some embodiments, the information about the first or second candidate beam includes a corresponding synchronization signal block resource indicator, SSBRI, or a channel state information reference signal resource indicator, CRI, reported in the MAC-CE. In some embodiments, the information about at least one of the first and second candidate beam is contained in an octet and at least one the first and second beam indicator indicates one of a presence and absence of the octet in the MAC CE. In some embodiments, each of the first and second beam indicators is carried by one bit in the MAC CE, wherein the corresponding candidate beam information is present when the bit is set to one, and is absent when the bit is set to zero. In some embodiments, when a list of candidate beams is not configured, no candidate beam information is included in the MAC CE.

In some embodiments, the method includes configuring the MAC CE with multiple sets of candidate beam information in multiple second bit fields, each set corresponding to a different serving cell.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates a 14 symbol slot;

FIG. 2 illustrates an NR time-frequency resource grid;

FIG. 3 illustrates transmission and reception of two beam pairs each beam pair being associated with a different CSI-RS;

FIG. 4 illustrates an association of PUSCH power control parameters related to an SRI field;

FIG. 5 illustrates a single entry MAC CE;

FIG. 6 illustrates a first multiple entry MAC CE;

FIG. 7 illustrates a second multiple entry MAC CE;

FIG. 8 illustrates successive PUSCH transmissions for scheduled for different beams by a DCI;

FIG. 9 is a schematic diagram of an example network architecture illustrating a communication system according to principles disclosed herein;

FIG. 10 is a block diagram of a network node in communication with a wireless device over a wireless connection according to some embodiments of the present disclosure;

FIG. 11 is a flowchart of an example process in a network node for medium access control (MAC) control element (CE) design for multiple power management maximum power reduction (P-MPR) reporting;

FIG. 12 is a flowchart of an example process in a wireless device for medium access control (MAC) control element (CE) design for multiple power management maximum power reduction (P-MPR) reporting;

FIG. 13 is a flowchart of another example process in a network node for medium access control (MAC) control element (CE) design for multiple power management maximum power reduction (P-MPR) reporting;

FIG. 14 is a flowchart of another example process in a wireless device for medium access control (MAC) control element (CE) design for multiple power management maximum power reduction (P-MPR) reporting;

FIG. 15 is an example configuration of a MAC CE according to principles set forth herein;

FIG. 16 is another example configuration of a MAC CE with one less octet than the MAC CE configuration of FIG. 15 according to principles set forth herein; and

FIG. 17 is another example configuration of a MAC CE for multiple serving cells according to principles set forth herein.

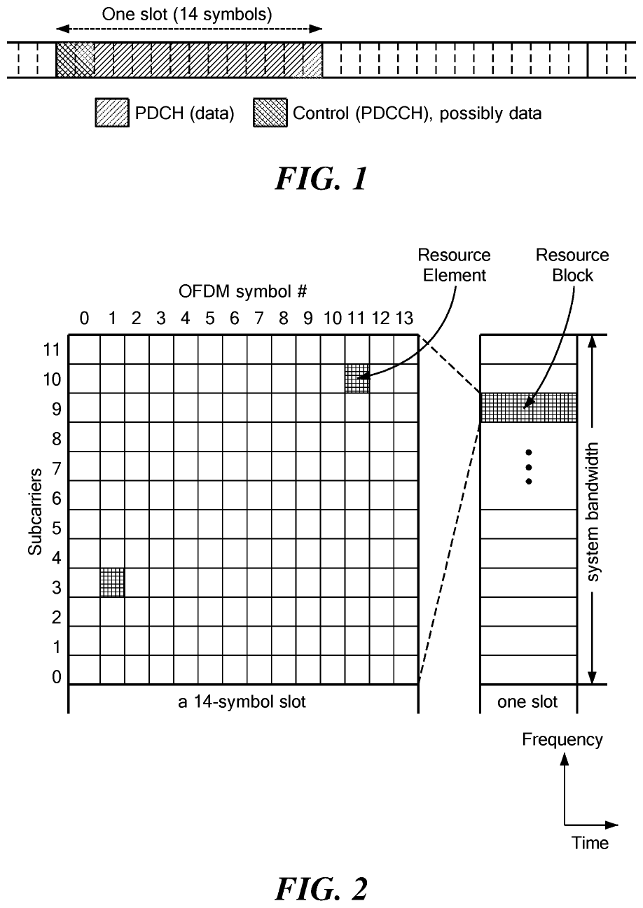

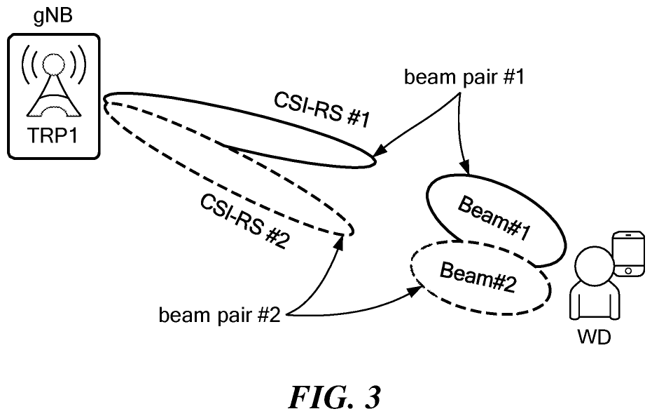

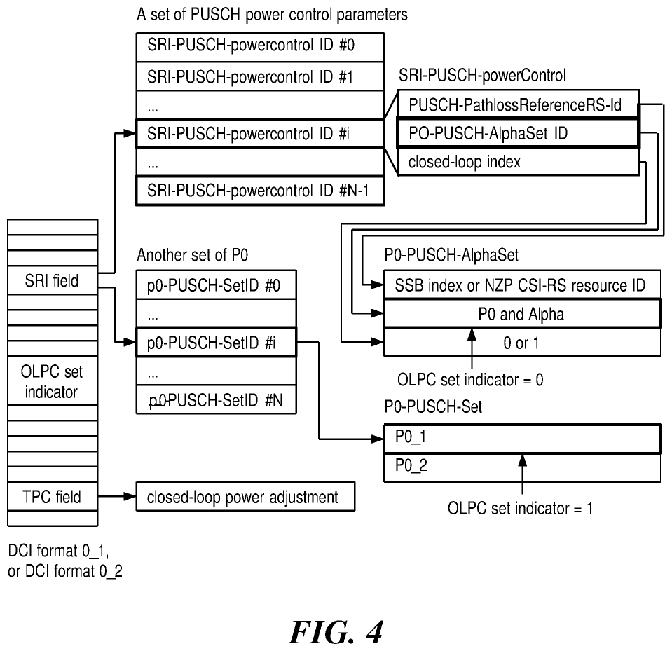

### DETAILED DESCRIPTION

Before describing in detail example embodiments, it is noted that the embodiments reside primarily in combinations of apparatus components and processing steps related to medium access control (MAC) control element (CE) design for multiple power management maximum power reduction (P-MPR) reporting. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to medium access control (MAC) control element (CE) design for multiple power management maximum power reduction (P-MPR) reporting.

Referring again to the drawing figures, in which like elements are referred to by like reference numerals, there is shown in FIG. 9 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

A network node 16 (eNB or gNB) is configured to include a MAC CE decoder 24 which is configured to determine, based on a bit content of a one field of the MAC CE whether a P-MPR value is reported in another field of the MAC CE. In some embodiments, the MAC CE decoder 24 is configured to determine a presence of candidate beam information in the MAC CE based at least in part on a bit content in at least one field of the MAC CE. A wireless device 22 is configured to include a MAC CE configuration unit 26 which is configured to configure a medium access control, MAC, control element, CE, to include: N power management maximum power reduction, P-MPR, values, N being an integer greater than zero; and at least one indicator indicating whether a P-MPR value is included in a corresponding field of the MAC CE. In some embodiments, the MAC CE configuration unit 26 is configured to adjust a size of the MAC CE based at least in part on a number of second bit fields to be included in the MAC CE.

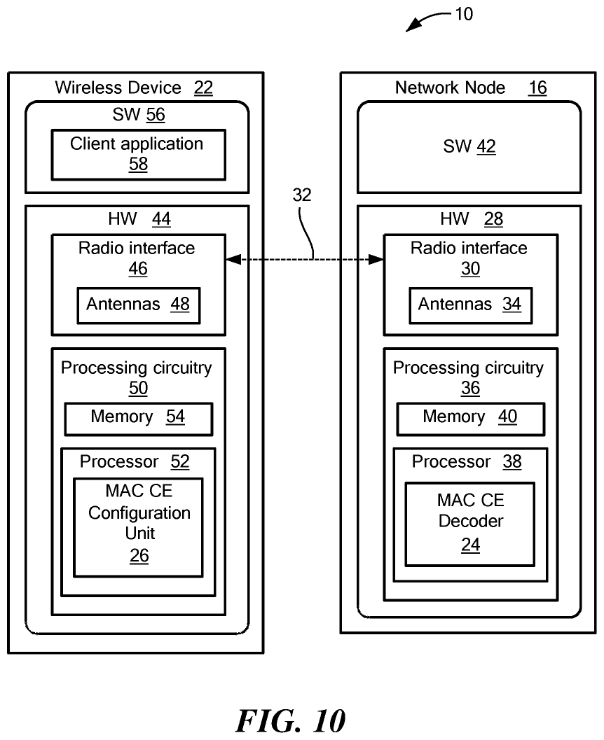

Example implementations, in accordance with an embodiment, of the WD 22 and network node 16 discussed in the preceding paragraphs will now be described with reference to FIG. 10.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include a MAC CE decoder 24 which is configured to determine, based on a bit content of a one field of the MAC CE whether a P-MPR value is reported in another field of the MAC CE. In addition, or in the alternative, in some embodiments, the MAC CE decoder 24 is configured to determine a presence of candidate beam information in the MAC CE based at least in part on a bit content in at least one field of the MAC CE.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include a MAC CE configuration unit 26 which is configured to configure a medium access control, MAC, control element, CE, to include: N power management maximum power reduction, P-MPR, values, N being an integer greater than zero; and at least one indicator indicating whether a P-MPR value is included in a corresponding field of the MAC CE. In addition, or in the alternative, the MAC CE configuration unit 26 is configured to adjust a size of the MAC CE based at least in part on a number of second bit fields to be included in the MAC CE.

In some embodiments, the inner workings of the network node 16 and WD 22 may be as shown in FIG. 10 and independently, the surrounding network topology may be that of FIG. 9.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 9 and 10 show various “units” such as MAC CE decoder 24 and MAC CE configuration unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

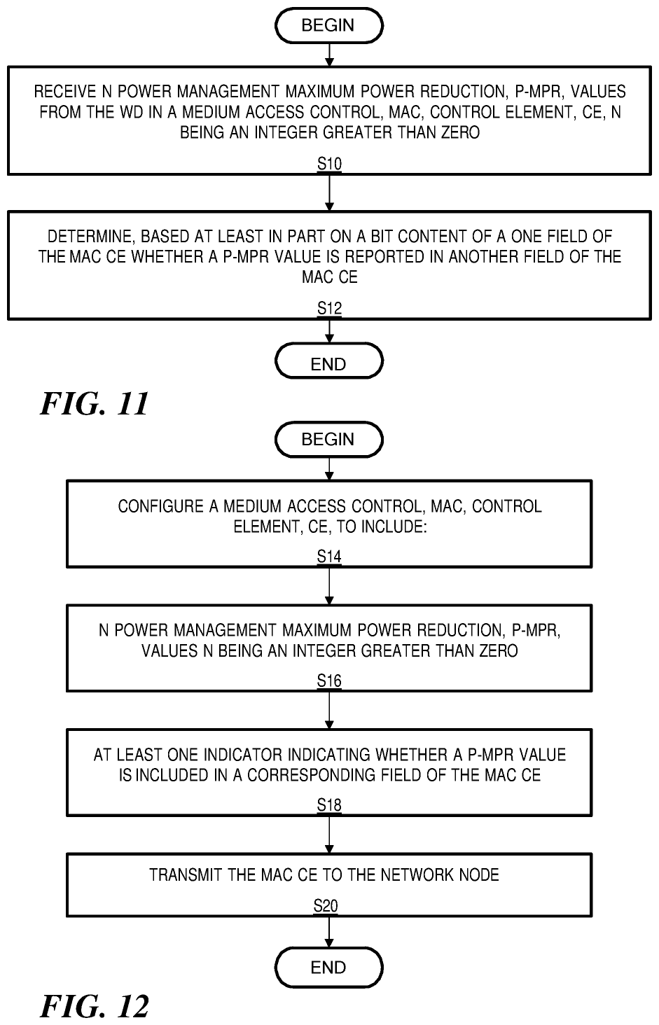

FIG. 11 is a flowchart of an example process in a network node 16 for medium access control (MAC) control element (CE) design for multiple power management maximum power reduction (P-MPR) reporting. One or more blocks described herein may be performed by one or more elements of network node 16 such as by one or more of processing circuitry 36 (including the MAC CE decoder 24), processor 38, and/or radio interface 30. Network node 16 such as via processing circuitry 36 and/or processor 38 and/or radio interface 30 is configured to receive N power management maximum power reduction, P-MPR, values from the WD in a medium access control, MAC, control element, CE, N being an integer greater than zero (Block S10); and determining, based on a bit content of a one field of the MAC CE whether a P-MPR value is reported in another field of the MAC CE (Block S12).

In some embodiments, the process includes, when a P-MPR value is determined to be reported, determining a corresponding synchronization signal/physical broadcast channel resource block indicator, SSBRI/CRI, reported in the MAC-CE. In some embodiments, mapping the process includes reporting of P-MPR values to fields in the MAC CE.

FIG. 12 is a flowchart of an example process in a wireless device 22 according to some embodiments of the present disclosure. One or more blocks described herein may be performed by one or more elements of wireless device 22 such as by one or more of processing circuitry 50 (including the MAC CE configuration unit 26), processor 52, and/or radio interface 46. Wireless device 22 such as via processing circuitry 50 and/or processor 52 and/or radio interface 46 is configured to configure a medium access control, MAC, control element, CE, to include (Block S14): N power management maximum power reduction, P-MPR, values, N being an integer greater than zero (Block S16); and at least one indicator indicating whether a P-MPR value is included in a corresponding field of the MAC CE (Block S18). The process also includes transmitting the MAC CE to, for example, the network node (Block S20).

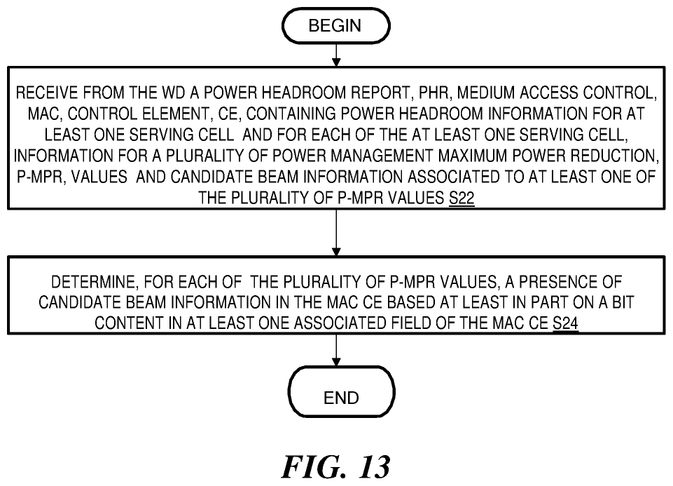

FIG. 13 is a flowchart of another example process in a network node 16 for medium access control (MAC) control element (CE) design for multiple power management maximum power reduction (P-MPR) reporting. One or more blocks described herein may be performed by one or more elements of network node 16 such as by one or more of processing circuitry 36 (including the MAC CE decoder 24), processor 38, and/or radio interface 30. Network node 16 such as via processing circuitry 36 and/or processor 38 and/or radio interface 30 is configured to receive from the WD a power headroom report, PHR, medium access control, MAC, control element, CE, that includes power headroom information for at least one serving cell and for each of the at least one serving cell, information for a plurality of power management maximum power reduction, P-MPR, values and candidate beam information associated to at least one of the plurality of P-MPR values (Block S22). The method also includes determining, for each of the plurality of P-MPR values, a presence of candidate beam information in the MAC CE based at least in part on a bit content in at least one associated field of the MAC CE (Block S24).

In some embodiments, the bit content includes a first bit indicating whether first candidate beam information associated with a first P-MPR value is present in a first field of the MAC CE and includes a second bit indicating whether second candidate beam information associated with a second P-MPR value is present in a second field of the MAC CE. In some embodiments, the candidate beam information includes at least one of a corresponding synchronization signal block resource indicator, SSBRI, and a channel state information reference signal resource indicator, CRI, reported in the MAC-CE. In some embodiments, the bit content determines a variable size of the MAC CE. In some embodiments, the bit content is associated with an octet of the MAC CE, wherein the octet containing a SSBRI or CRI, and a bit of the bit content indicates a presence of the octet in the MAC CE. In some embodiments, a bit indicating a presence of candidate beam information in the MAC CE is determined based at least in part on the corresponding P-MPR value for meeting a maximum permissible exposure, MPE, requirement.

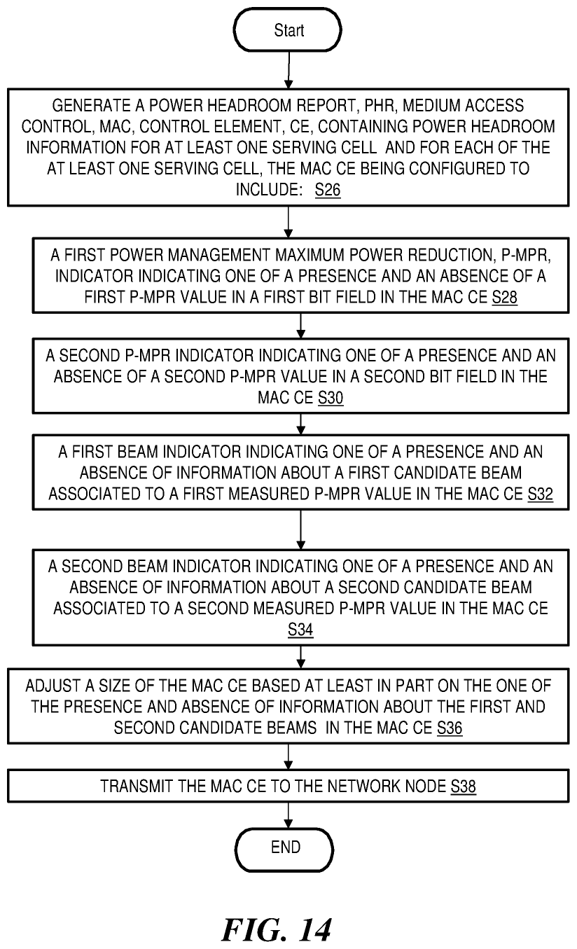

FIG. 14 is a flowchart of another example process in a wireless device 22 according to some embodiments of the present disclosure. One or more blocks described herein may be performed by one or more elements of wireless device 22 such as by one or more of processing circuitry 50 (including the MAC CE configuration unit 26), processor 52, and/or radio interface 46. Wireless device 22 such as via processing circuitry 50 and/or processor 52 and/or radio interface 46 is configured to generate a power headroom report, PHR, Medium Access Control, MAC, Control Element, CE, containing power headroom information for one or more serving cells and for each of the one or more serving cells (Block S26), the MAC CE being configured to include: a first power management maximum power reduction, P-MPR, indicator indicating the presence or absence of a first P-MPR value in a first bit field in the MAC CE (Block S28); a second P-MPR indicator indicating one of a presence and an absence of a second P-MPR value in a second bit field in the MAC CE (Block S30); a first beam indicator indicating the presence or absence of information about a first candidate beam associated to the first measured P-MPR value in the MAC CE (Block 32; and a second beam indicator indicating the presence or absence of information about a second candidate beam associated to the second measured P-MPR value in the MAC CE (S34). The method also includes adjusting a size of the MAC CE based at least in part on the presence or absence of information about the first and second candidate beams in the MAC CE (Block S36). The method also includes transmitting the MAC CE to the network node (Block S38).

In some embodiments, the information about the first or second candidate beam includes a corresponding synchronization signal block resource indicator, SSBRI, or a channel state information reference signal resource indicator, CRI, reported in the MAC-CE. In some embodiments, information about at least one of the first and second candidate beam is contained in an octet and at least one of the first and second beam indicator indicates one of a presence and an absence of the octet in the MAC CE. In some embodiments, each of the first and second beam indicators is carried by one bit in the MAC CE, and wherein corresponding candidate beam information is present when the bit is set to one, and is absent when the bit is set to zero. In some embodiments, when a list of candidate beams is not configured, no candidate beam information is included in the MAC CE. In some embodiments, the method also includes configuring the MAC CE with multiple sets of candidate beam information in multiple second bit fields, each set corresponding to a different serving cell.

Having described the general process flow of arrangements of the disclosure and having provided examples of hardware and software arrangements for implementing the processes and functions of the disclosure, the sections below provide details and examples of arrangements for medium access control (MAC) control element (CE) design for multiple power management maximum power reduction (P-MPR) reporting.

As used herein, a P-MPR value may be referred to as a P-MPR MPE value or simply as an MPE value. The threshold value described in the following embodiments may be the threshold P-MPR_00 defined above or it may be a RRC configured parameter to the WD 22.

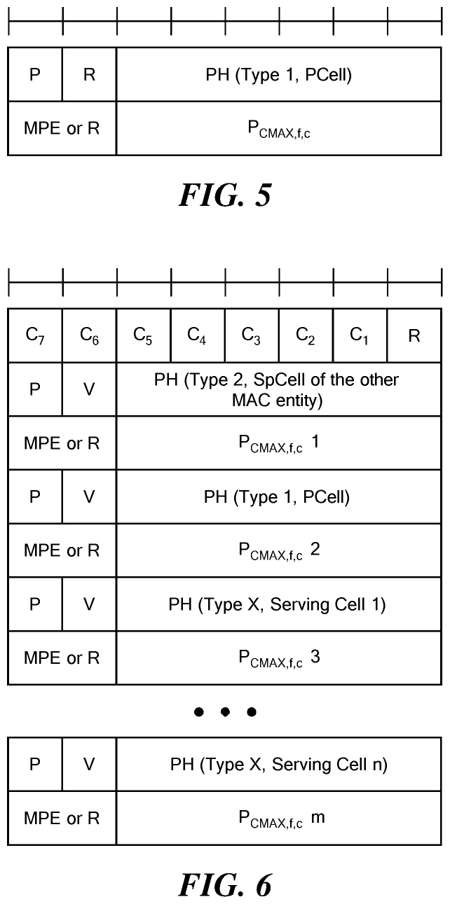

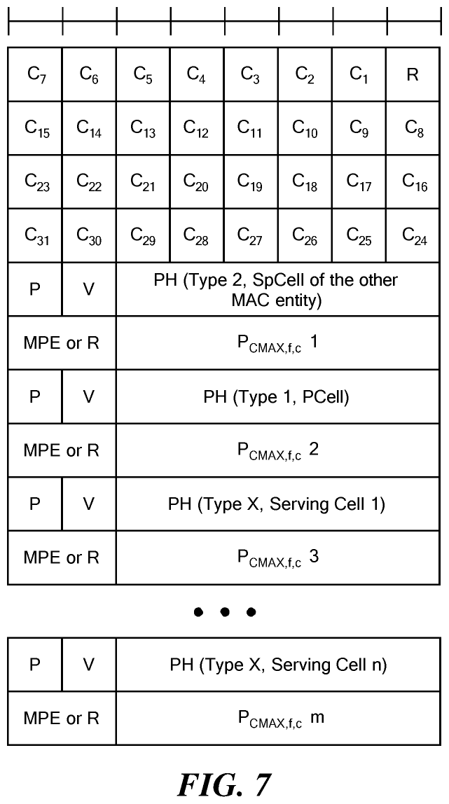

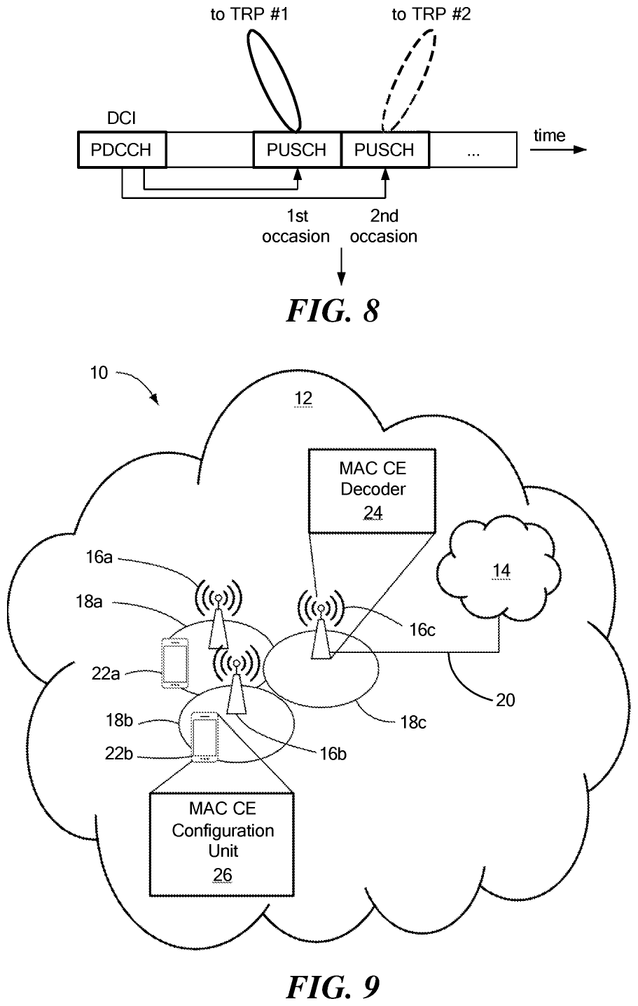

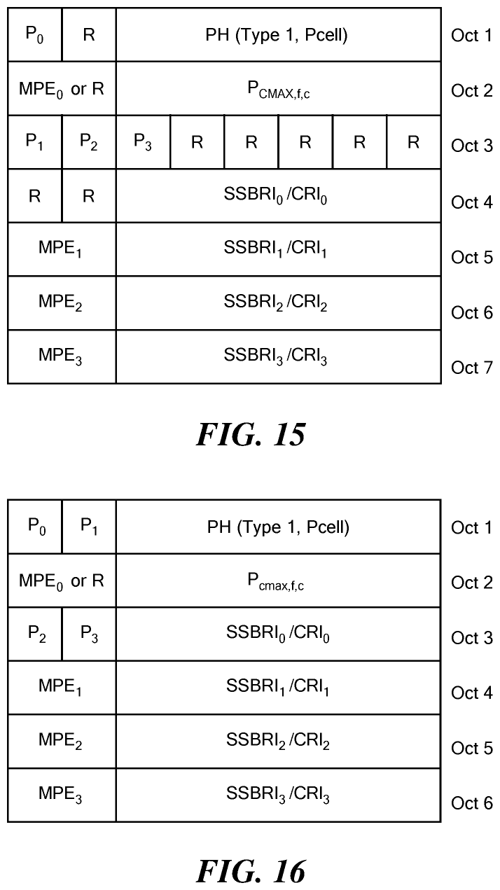

To control the size of the MAC CE for reporting multiple MPE values, a variable size single entry PHR MAC CE is disclosed with more than 2 Octets as shown in FIG. 15. Note that this disclosed single entry PHR MAC CE is different from the single entry PHR MAC CE supported in 3GPP Rel-16 which is shown in FIG. 5. The single entry PHR MAC CE shown in in FIG. 5 is a fixed size MAC CE with size of two octets. On the other hand, the single entry PHR MAC CE disclosed herein includes fields to control whether octet(s) carrying one or more of MPE fields and/or SSBRI/CRI fields are present (in FIG. 15, the i^{th} MPE field is denoted as MPEᵢ and the corresponding candidate beam index is denoted as SSBRIᵢ/CRIᵢ). Some detailed embodiments are described below.

In some embodiments, if mpe-Reporting-FR2 is configured (and if the WD 22 has signaled in WD 22 capability signaling that it supports 3GPP Rel-17 enhanced P-MPR report) or if a new parameter for example called mpe-Reporting-FR2-r17 is configured and the Serving Cell operates on FR2, the P₀ field shown in FIG. 15 may indicate whether the first MPE value MPE₀ is reported. For instance, if the MPE value to meet MPE requirements is less than a first threshold (e.g., P-MPR_00 as defined above), and if the MPE value has not changed by more than a second threshold compared to the last P-MPR report (e.g., phr-Tx-PowerFactorChange dB as defined above), then the P₀ field may be set to 0 and the first MPE value MPE₀ is not reported in the MAC CE. In this case, the bits that would have carried MPE₀ are interpreted as reserved fields (i.e., the bits in the field denoted as ‘MPE₀ or R’ in FIG. 15 are interpreted as reserved bits). On the other hand, when P₀ is set to 1, the first MPE value MPE₀ is reported in the MAC CE (i.e., the bits in the field denoted as ‘MPE₀ or R’ in FIG. 15 are interpreted as the first MPE field MPE₀).

Note that since MPE₀ is in the same octet as P_{CMAX,f,c} which is reported regardless of whether ‘MPE₀’ is reported, the presence of the octet (oct) carrying ‘MPE₀ or R’ (i.e., octet 2 in FIG. 13) is not controlled by the bit P₀. However, if MPE₀ is not reported in the MAC CE, then the corresponding candidate beam index SSBRI₀/CRI₀ does not have to be included in the MAC CE. Hence, the presence of octet 4 shown in FIG. 15 is controlled by the bit P₀. That is, if P₀ is set to a value of 0, then octet 4 is not present in the MAC CE and the candidate beam index SSBRI₀/CRI₀ is not reported in the MAC CE. If P₀ is set to a value of 1, then octet 4 is present in the MAC CE and the candidate beam index SSBRI₀/CRI₀ is reported in the MAC CE as part of octet 4. This embodiment is one example of the case where a control field (e.g., 1 bit P₀) only controls the presence of an octet containing the candidate beam index field (i.e., SSBRI₀/CRI₀ field) while not containing the octet containing the corresponding MPE field (i.e., MPE₀ field).

Although the example of FIG. 15 shows specific field lengths for certain fields (e.g., SSBRIᵢ/CRIᵢ fields are assumed to be 6 bit fields in the figure), the above embodiment is non-limiting and may be applicable to other cases where field lengths are different than those shown in the FIG. 15 (e.g., SSBRIᵢ/CRIᵢ fields with lengths other than 6 bits).

In some embodiments, the field Pᵢ (where i=1, 2, 3) shown in FIG. 15 jointly controls whether the MPEᵢ value and the associated SSBRIᵢ/CRIᵢ value are reported in the MAC CE. In addition, the field Pᵢ also controls the whether the octet containing MPEᵢ field and the associated SSBRIᵢ/CRIᵢ field. If the MPE value MPEᵢ to meet MPE requirements is less than a threshold (e.g., P-MPR_00 as defined above), the Pᵢ field may be set to 0 and the MPE value MPEᵢ and the associated SSBRIᵢ/CRIᵢ are not reported in the MAC CE. In this case, the octet containing the MPEᵢ field and the associated SSBRIᵢ/CRIᵢ field is omitted from the MAC CE. In the example of FIG. 15, when Pᵢ is set to 0, then octet 5 containing the MPE₁ field and the associated SSBRI₁/CRI₁ field is omitted. On the other hand, when Pᵢ is set to 1, the MPE value MPEᵢ and the associated SSBRIᵢ/CRIᵢ field are reported in the MAC CE. In this case, the octet containing the MPEᵢ field and the associated SSBRIᵢ/CRIᵢ field is present in the MAC CE. In the example of FIG. 15, when P₁ is set to 1, then octet 5 containing the MPE₁ field and the associated SSBRI₁/CRI₁ field is present in the MAC CE.

In some embodiments, the P₁, P₂, and P₃ may be set to different values depending on the MPE₁, MPE₂, and MPE₃ values needed to meet MPE requirements when compared to a threshold). For instance, consider the case where MPE₁ is below a threshold (e.g., MPE₁<P-MPR_00) while MPE₂ and MPE₃ are above the threshold (e.g., MPE₂>P-MPR_00 and MPE₃>P-MPR_00). Then, the following content may be included in the MAC CE:
Pᵢ is set to 0; P₂ and P₃ are set to 1;
MPE₁ and associated SSBRI₁/CRI₁ are not reported in the MAC CE; Octet 5 containing MPE₁ field and associated SSBRI₁/CRI₁ field is omitted in the MAC CE;
MPE₂ and associated SSBRI₂/CRI₂ are reported in the MAC CE; Octet 6 containing MPE₂ field and associated SSBRI₂/CRI₂ field is present in the MAC CE; and/or
MPE₃ and associated SSBRI₃/CRI₃ are reported in the MAC CE; Octet 7 containing MPE₃ field and associated SSBRI₃/CRI₃ field is present in the MAC CE.

Hence, depending on which among the multiple MPE values are to be reported, with the above embodiments, the WD 22 may control the size of the MAC CE by appropriately setting the Pᵢ bits.

In some embodiments, P₁ to P₃ may not be allocated a separate octet, and instead combined with other fields as shown in the example of FIG. 16. This arrangement saves one octet as compared to the example shown in FIG. 15.

In some embodiments, the R fields in the above embodiments, (or new additional fields), are used to explicitly indicate if the SSBRI/SRI fields are included in the MAC-CE. For example, up to 4 of the R fields may be re-made in to 4 K-fields (K0, K1, K2, and K3) where each K field indicates if a corresponding SSBRI/CRI is included in the MAC-CE. In one version of this embodiment, in case P0 field is set to 1, and K0 is set to 1, the SSBRI0/CRI0 is included in the MAC-CE. In one alternate of this embodiment, if P0 field is set to 1, and K0 is set to 0, the SSBRI0/CRI0 is not included in the MAC-CE. In another alternate of this embodiment, in case the P0 field is set to 0, and K0 is set to 0, the SSBRI0/CRI0 is not included in the MAC-CE. In yet another alternate of this embodiment, in case P0 field is set to 0, and K0 is set to 1, the SSBRI0/CRI0 is included in the MAC-CE (which for example may be useful in case the WD 22 has detected a better beam, even though a non-MPE event was triggered).

The method to explicitly indicate the presence of SSBRI/CRI fields in the MAC-CE could be useful for example in case the WD 22 does not find a suitable candidate beam to include in the PHR report, or in case the set of candidate beams used to determine the SSBR/CRI is not configured.

In one embodiment, a single K field may be included in the MAC-CE (instead of multiple K fields), which indicates if the MAC-CE may include any SSBRI/CRIS. For example, in case the K field is set to 1, the WD 22 may expect that SSBRI/CRI may be included in the MAC-CE (for example depending on the values of corresponding P field as described above), and if the K field is set to 0, no SSBRI/CRI field may be included in the MAC-CE regardless of the P field values.

In some embodiments, in cases where the list of candidate beams for the enhanced P-MPR report (which the WD 22 uses to determine the SSBRI/CRI(s)) is not configured, the SSBRI/CRI fields are not included in the MAC-CE.

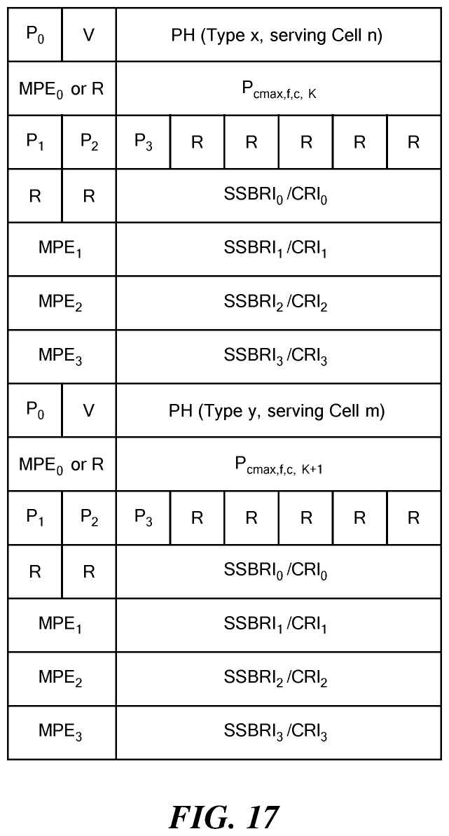

The MAC CE design example shown in FIG. 15 may also be extended to the multiple entry MAC CEs by appending Oct3 to Oct7 (octets 3 through 7) in FIG. 15 to the PH report associated with each serving cell. An example is shown in FIG. 17.

Some embodiments may include one or more of the following:

Embodiment A1. A network node configured to communicate with a wireless device, WD, the network node configured to, and/or comprising a radio interface and/or comprising processing circuitry configured to:
receive N power management maximum power reduction, P-MPR, values from the WD in a medium access control, MAC, control element, CE, N being an integer greater than zero; and
determine, based at least in part on a bit content of a one field of the MAC CE, whether a P-MPR value is reported in another field of the MAC CE.

Embodiment A2. The network node of Embodiment A1, wherein, when a P-MPR value is determined to be reported, the network node, processing circuitry and/or radio interface are further configured to determine a corresponding synchronization signal/physical broadcast channel resource block indicator, SSBRI/CRI, reported in the MAC-CE.

Embodiment A3. The network node of any of Embodiments A1 and A2, wherein the network node, processing circuitry and/or radio interface are further configured to map reporting of P-MPR values to fields in the MAC CE.

Embodiment B1. A method implemented in a network node that is configured to communicate with a wireless device, the method comprising:
receiving N power management maximum power reduction, P-MPR, values from the WD in a medium access control, MAC, control element, CE, N being an integer greater than zero; and
determining, based at least in part on a bit content of a one field of the MAC CE, whether a P-MPR value is reported in another field of the MAC CE.

Embodiment B2. The method of Embodiment B1, further comprising, when a P-MPR value is determined to be reported, determining a corresponding synchronization signal/physical broadcast channel resource block indicator, SSBRI/CRI, reported in the MAC-CE.

Embodiment B3. The method of any of Embodiments B1 and B2, further comprising mapping reporting of P-MPR values to fields in the MAC CE.

Embodiment C1. A wireless device, WD, configured to communicate with a network node, the WD configured to, and/or comprising a radio interface and/or processing circuitry configured to:
configure a medium access control, MAC, control element, CE, to include:
   N power management maximum power reduction, P-MPR, values, N being an integer greater than zero; and
   at least one indicator indicating whether a P-MPR value is included in
a corresponding field of the MAC CE; and transmit the MAC CE to, for example, the network node.

Embodiment C2. The WD of Embodiment C1, wherein the MAC CE is further configured to include a synchronization signal/physical broadcast channel resource block indicator, SSBRI/CRI for each indicated P-MPR.

Embodiment C3. The WD of any of Embodiments C1 and C2, wherein the WD, processing circuitry and/or radio interface is further configured to map the N P-MPR fields to fields in the MAC CE.

Embodiment C4. The WD of any of Embodiments C₁-C₃, wherein the at least one indicator includes N indicators, each of the N indicators corresponding to one of the N P-MPR values.

Embodiment C5. The WD of Embodiment C4, wherein each of the N indicators indicates whether a corresponding one of the N P-MPR values exceeds a threshold.

Embodiment D1. A method implemented in a wireless device (WD) that is configured to communicate with a network node, the method comprising:
configuring a medium access control, MAC, control element, CE, to include:
   N power management maximum power reduction, P-MPR, values, N being an integer greater than zero; and
   at least one indicator indicating whether a P-MPR value is included in a corresponding field of the MAC CE; and
transmitting the MAC CE to, for example, the network node.

Embodiment D2. The method of Embodiment D1, wherein the MAC CE is further configured to include a synchronization signal/physical broadcast channel resource block indicator, SSBRI/CRI for each indicated P-MPR.

Embodiment D3. The method of any of Embodiments D1 and D2, further comprising mapping the N P-MPR fields to fields in the MAC CE.

Embodiment D4. The method of any of Embodiments D1-D3, wherein the at least one indicator includes N indicators, each of the N indicators corresponding to one of the N P-MPR values.

Embodiment D5. The method of Embodiment D4, wherein each of the N indicators indicates whether a corresponding one of the N P-MPR values exceeds a threshold.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node comprising:
a radio interface configured to receive from the WD a power headroom report, PHR, medium access control, MAC, control element, CE, containing power headroom information for at least one serving cell, and for each of the at least one serving cell the MAC CE comprising:
a first power management maximum power reduction, P-MPR, indicator indicating one of a presence and an absence of a first maximum permissible exposure, MPE, value in a first bit field in the MAC CE;
a second P-MPR indicator indicating one of a presence and an absence of a second MPE value in a second bit field in the MAC CE;
a first beam indicator indicating one of a presence and an absence of information about a first candidate beam associated to a first measured P-MPR value in the MAC CE;
a second beam indicator indicating one of a presence and an absence of information about a second candidate beam associated to a second measured P-MPR value in the MAC CE; and
a size of the MAC CE being based at least in part on the one of the presence and absence of information about the first and second candidate beams in the MAC CE, the first and second MPE values being included in the PHR MAC CE only when a corresponding P-MPR value exceeds a threshold; and
processing circuitry in communication with the radio interface and configured to determine, for each of the plurality of P-MPR values, a presence of candidate beam information in the MAC CE based at least in part on a bit content in at least one associated field of the MAC CE.

2. (canceled)

3. The network node of claim 1, wherein the information about the first or second beam includes a corresponding synchronization signal block resource indicator, SSBRI, or a channel state information reference signal resource indicator, CRI, reported in the MAC-CE.

4. (canceled)

5. The network node of claim 1, wherein;
information about at least one of the first and second candidate beam is contained in an octet of the MAC CE; and
at least one of the first and second beam indicator indicates one of a presence and an absence of the octet in the MAC CE.

6. The network node of claim 1, wherein each of the first and second beam indicators is carried by one bit in the MAC CE, and wherein corresponding candidate beam information is present when the bit is set to one, and is absent when the bit is set to zero.

7. A method in a network node configured to communicate with a wireless device, WD, the method comprising:
receiving from the WD a power headroom report, PHR, medium access control, MAC, control element, CE, that includes power headroom information for at least one serving cell, and for each of the at least one serving cell the MAC CE comprising:
a first power management maximum power reduction, P-MPR, indicator indicating one of a presence and an absence of a first maximum permissible exposure, MPE, value in a first bit field in the MAC CE;
a second P-MPR indicator indicating one of a presence and an absence of a second MPE value in a second bit field in the MAC CE;
a first beam indicator indicating one of a presence and an absence of information about a first candidate beam associated to a first measured P-MPR value in the MAC CE;
a second beam indicator indicating one of a presence and an absence of information about a second candidate beam associated to a second measured P-MPR value in the MAC CE; and
a size of the MAC CE being based at least in part on the one of the presence and absence of information about the first and second candidate beams in the MAC CE, the first and second MPE values being included in the PHR MAC CE only when a corresponding P-MPR value exceeds a threshold; and
determining, for each of the plurality of P-MPR values, a presence of candidate beam information in the MAC CE based at least in part on a bit content in at least one associated field of the MAC CE.

8. (canceled)

9. The method of claim 7, wherein the information about the first or second beam includes a corresponding synchronization signal block resource indicator, SSBRI, or a channel state information reference signal resource indicator, CRI, reported in the MAC-CE.

10. (canceled)

11. The method of claim 7, wherein:
information about at least one of the first and second candidate beam is contained in an octet of the MAC CE; and
at least one of the first and second beam indicator indicates one of a presence and an absence of the octet in the MAC CE.

12. The method of claim 7, wherein each of the first and second beam indicators is carried by one bit in the MAC CE, and wherein corresponding candidate beam information is present when the bit is set to one, and is absent when the bit is set to zero.

13. A wireless device, WD, configured to communicate with a network node, the WD comprising:
processing circuitry configured to:
generate a power headroom report, PHR, Medium Access Control, MAC, Control Element, CE, containing power headroom information for at least one serving cell, and for each of the at least one serving cell, the MAC CE being configured to include:
a first power management maximum power reduction, P-MPR, indicator indicating one of a presence and an absence of a first maximum permissible exposure, MPE, value in a first bit field in the MAC CE;
a second P-MPR indicator indicating one of a presence and an absence of a second MPE value in a second bit field in the MAC CE;
a first beam indicator indicating one of a presence and an absence of information about a first candidate beam associated to a first measured P-MPR value in the MAC CE; and
a second beam indicator indicating one of a presence and an absence of information about a second candidate beam associated to a second measured P-MPR value in the MAC CE; and
a size of the MAC CE being based at least in part on the one of the presence and absence of information about the first and second candidate beams in the MAC CE, the first and second MPE values being included in the PHR MAC CE only when a corresponding P-MPR value exceeds a threshold; and
a radio interface in communication with the processing circuitry and configured to transmit the MAC CE to the network node.

14. The WD of claim 13, wherein the information about the first or second candidate beam includes a corresponding synchronization signal block resource indicator, SSBRI, or a channel state information reference signal resource indicator, CRI, reported in the MAC-CE.

15. The WD of claim 13, wherein information about at least one of the first and second candidate beam is contained in an octet and at least one of the first and second beam indicator indicates one of a presence and an absence of the octet in the MAC CE.

16. The WD of claim 12, wherein each of the first and second beam indicators is carried by one bit in the MAC CE, and wherein corresponding candidate beam information is present when the bit is set to one, and is absent when the bit is set to zero.

17. (canceled)

18. (canceled)

19. A method in a wireless device, WD, configured to communicate with a network node, method comprising:
generating a power headroom report, PHR, Medium Access Control, MAC, Control Element, CE, containing power headroom information for at least one serving cell, and for each of the at least one serving cell, the MAC CE being configured to include:
a first power management maximum power reduction, P-MPR, indicator indicating one of a presence and an absence of a first maximum permissible exposure, MPE, value in a first bit field in the MAC CE;
a second P-MPR indicator indicating one of a presence and an absence of a second MPE value in a second bit field in the MAC CE;
a first beam indicator indicating one of a presence and an absence of information about a first candidate beam associated to a first measured P-MPR value in the MAC CE; and
a second beam indicator indicating one of a presence and an absence of information about a second candidate beam associated to a second measured P-MPR value in the MAC CE;
a size of the MAC CE being based at least in part on the one of the presence and absence of information about the first and second candidate beams in the MAC CE, the first and second MPE values being included in the PHR MAC CE only when a corresponding P-MPR value exceeds a threshold; and
transmitting the MAC CE to the network node.

20. The method of claim 19, wherein the information about the first or second candidate beam includes a corresponding synchronization signal block resource indicator, SSBRI, or a channel state information reference signal resource indicator, CRI, reported in the MAC-CE.

21. The method of claim 19, wherein information about at least one of the first and second candidate beam is contained in an octet and at least one of the first and second beam indicator indicates one of a presence and an absence of the octet in the MAC CE.

22. The method of claim 19, wherein each of the first and second beam indicators is carried by one bit in the MAC CE, and wherein corresponding candidate beam information is present when the bit is set to one, and is absent when the bit is set to zero.

23. (canceled)

24. (canceled)
